(19) United States
(12) Patent Application Publication
(10) Pub. No.: US 2021/0228317 A1
(43) Pub. Date: Jul. 29, 2021

(54) APPARATUS AND METHOD FOR DENTAL CLAMPING

(71) Applicant: CYBERDONTICS INC., San Francisco, CA (US)

(72) Inventors: Christopher John CIRIELLO, San Francisco, CA (US); James JACKSON, Victoria, BC (CA); Nathan John MULLER, Victoria, BC (CA); Brian Edward KING, Vancouver, BC (CA); Alec John LILLIS, Toronto (CA)

(21) Appl. No.: 17/054,442

(22) PCT Filed: May 9, 2019
(86) PCT No.: PCT/IB2019/000578

§ 371 Date: Nov. 10, 2020

Related U.S. Application Data
(60) Provisional application No. 62/669,934, filed on May 10, 2018.
(60) Provisional application No. 62/727,390, filed on Sep. 5, 2018.
(60) Provisional application No. 62/755,961, filed on Nov. 5, 2018.
(60) Provisional application No. 62/755,989, filed on Nov. 5, 2018.
(60) Provisional application No. 62/830,951, filed on Apr. 8, 2019.

(51) Int. Cl. A61C 5/80; A61C 1/00; A61C 9/00

(52) U.S. Cl. CPC A61C 5/80; A61C 1/0007; A61C 2201/00; A61C 1/0061; A61C 9/0053

(57) ABSTRACT

An apparatus and method for automated dental treatment having a tooth clamp (48, 700) which connects an automated dental drill (10). The tooth clamp (700) has a rigid frame (704A, 704B) with a coupling point (703) for reversibly coupling the tooth clamp (700) to an automated dental drill (10) and a pair of jaws (701A, 701B) for coupling the clamp to a tooth of a user. A first jaw surface has a shape adapted to mate the tooth surface and is fabricated based on surface data or a three-dimensional model of the scanned tooth. The tooth clamp (700) has suction ports (702) and the system (900) has irrigation nozzles (903).

### CROSS-REFERENCE

This application claims the benefit of U.S. Provisional Patent Application No. 62/669,934, filed on May 10, 2018, U.S Provisional Patent Application No. 62/727,390, filed on Sep. 5, 2018, U.S. Provisional Patent Application No. 62/755,961, filed on Nov. 5, 2018, U.S. Provisional Patent Application No. 62/755,989, filed on Nov. 5, 2018, and U.S. Provisional Patent Application No. 62/830,951, filed on Apr. 8, 2019, each of which is entirely incorporated herein by reference.

### BACKGROUND

Although advances have been made in recent years for the treatment of specific dental diseases, the actual delivery of dental treatment remains a manually intensive process. Accordingly, there is a need for methodology for automating dental treatment.

### SUMMARY

The existing dental treatment apparatuses or systems are unable to achieve automated dental treatment, e.g., automated tooth cutting. The existing apparatuses or systems rely on vision systems (e.g., human vision, real-time images of the teeth) for carrying out dental treatment, and there are major technical challenge(s) and regulatory risk(s) associated with automation of the vision-based dental treatment methods. Further, automation attempts utilizing expensive robotic arms can put the price point to above $100K for the dental treatment system(s) and are unlikely to be approved for full automation by the FDA due to the large working envelope in which its arms could cause damage. Thus, there is an urgent and unmet need for automating dental treatment with cost-effective, safe, and reliable apparatuses and systems. Also, one of the applications herein is to cut the teeth for crowns (cutting teeth themselves), not for dental drilling in surgery (drilling bore holes into bone for dental implants).The present disclosure relates to apparatuses, systems and methods for automating dental treatment.

In some embodiments, the present disclosure herein includes a tooth clamp which connects the computer numerical control (CNC) directed systems (e.g., the automated dental drill (ADD) system) to one or more teeth of the subject. In some embodiments, the tooth clamps disclosed herein are fabricated based on surface data of teeth of the subject. In some embodiments, the tooth clamp includes a specifically fabricated surface that mates to the tooth surfaces of the subject to retain teeth, protect soft tissue of the subject, provide positional reference to the CNC directed systems, provide an identical positional environment of the teeth relative to the CNC directed systems at different time points (e.g., during different patient visits to the dentist's office). Unlike existing systems and methods for dental surgery locating, the systems and methods here eliminate the need for fiducial tracking through optical means and rely on mechanical coupling mechanism(s) for accurate, reliable, and efficient dental positioning, e.g., identical positioning of teeth relative to the system for dental treatment during two different patient visits. In some embodiments, the tooth clamp herein provide anchoring for irrigation and/or suction apparatuses that are also used in automated dental treatment. In some embodiments, the apparatus, systems, and methods herein include dental adhesives, irrigation, suction, protection of the soft tissue that can work in combination with the tooth clamp or alone by themselves to facilitate automated dental treatment.

One aspect provided herein is an apparatus for dental clamping of a subject, the apparatus comprising: one or more frames comprising one or more coupling points, wherein the one or more coupling points reversibly couple the apparatus to an automated dental drill (ADD) system during a dental procedure; and one or more jaws, each comprising a first and second surface, the first surface comprising a shape adapted to mate one or more teeth of the subject and the second surface for attachment to the one or more frames, and wherein the one or more jaws provide positional reference to the tooth for the ADD system during the dental procedure.

In some embodiments, the first surface is fabricated based on surface data, a three-dimensional model, or both of the one or more teeth of the subject, representing a surface of the one or more teeth at the time of scanning. In some embodiments, the dental procedure is tooth cutting or drilling. In some embodiments, the one or more coupling points are configured for fixedly coupling the apparatus to the automated dental drill (ADD) system during tooth cutting. In some embodiments, relative movement of the apparatus to the ADD system during tooth cutting is within that of clinically acceptable thresholds. In some embodiments, the ADD system is configured for intraoral dental prosthetic preparation via automated tooth cutting. In some embodiments, the first surface envelopes a corresponding surface of the one or more teeth. In some embodiments, the one or more frames comprise one or more rigid materials. In some embodiments, the one or more jaws comprise one or more rigid materials. In some embodiments, the one or more rigid materials comprise one or more of: plastic, composite, metal, glass, porcelain, rubber, and alloy. In some embodiments, the one or more rigid materials comprise one or more of: polyether ether ketone (PEEK), polycarbonate, and acrylic. In some embodiments, the one or more jaws are fabricated using standard sized rigid materials using three-dimensional printing, molding, casting, computer numerical control (CNC) machining with a toolpath. In some embodiments, the positional reference to the tooth for the ADD system during the dental procedure is comprised of one or more degrees-of-freedom that are substantially zero. In some embodiments, the shape of the first surface or the second surface is three-dimensional. In some embodiments, the shape of the first surface is selected from a collection of pre-existing shapes. In some embodiments, the one or more suction ports are configured to connect to more than one orifice located at different portions of the apparatus. In some embodiments, the adhesive is at least partly on the first surface. In some embodiments, the first surface is generated at least partly based on three-dimensional surface data of the one or more teeth of the subject. In some embodiments, the three-dimensional surface data is generated based at least partly on one or more of: a two-dimensional X-ray image, a three-dimensional X-ray image, and a three-dimensional computed tomography (CT) scan.

Another aspect provided herein is a method for dental clamping of a subject, the method comprising: providing an apparatus to a user for dental clamping; allowing the user to clamp one or more jaws of the apparatus to engage one or more teeth of the subject at a first surface of the one or more jaws, wherein the one or more jaws are attached to one or more frames of the apparatus at a second surface thereof; allowing the user to couple the apparatus to an automated dental drill (ADD) system prior to tooth cutting by the ADD system, said coupling comprising coupling one or more coupling points of one or more frames of the apparatus reversibly to the ADD system; allowing the apparatus to either retain or funnel particulate runoffs to suction ports within the apparatus during the tooth cutting; allowing the user to uncouple the apparatus from automated dental drill (ADD) system subsequent to the tooth cutting by the ADD; and allowing the user to unclamp the one or more jaws from the subject.

In some embodiments, allowing a user to clamp the one or more jaws of the apparatus to engage the one or more teeth of the subject comprises squeezing two jaws toward each other to clamp an exterior of the teeth using a screw leverage, a material elastic force, a tensioned band force, or a combination thereof. In some embodiments, allowing a user to clamp the one or more jaws of the apparatus to engage the one or more teeth of the subject comprises squeezing two jaws toward each other to clamp an exterior of the teeth using an adhesive force on the one or more jaws that is configured for adhering the apparatus to the one or more teeth of the subject.

Another aspect provided herein is a system for intraoral dental prosthetic preparation of a subject via automated tooth cutting, the system comprising: an automated dental drill (ADD) system configured for automated tooth cutting of the subject; and an apparatus for dental clamping of the subject, the apparatus comprising: one or more frames comprising one or more coupling points, wherein the one or more coupling points reversibly couple the apparatus to the ADD system during tooth cutting; and one or more jaws, each comprising a first and second surface, the first surface for engaging one or more teeth of the subject and the second surface for attachment to the one or more frames, wherein the first surface is adapted to fit to the one or more teeth of the subject, and wherein the one or more jaws provide positional reference to the tooth for the ADD system, wherein the ADD system is configured to cut the one or more teeth automatically when the apparatus is coupled to the ADD and clamped on the one or more teeth.

Another aspect provided herein is a method for intraoral dental prosthetic preparation of a subject via automated tooth cutting, the method comprising: providing an apparatus to a user for dental clamping; allowing the user to clamp one or more jaws of the apparatus to engage one or more teeth of the subject at a first surface of the one or more jaws, wherein a shape of the surface is adapted to fit the one or more teeth wherein the one or more jaws are attached to one or more frames of the apparatus at a second surface of the one or more jaws; allowing the user to couple the apparatus to an automated dental drill (ADD) system prior to tooth cutting comprising coupling one or more coupling points reversibly to the ADD system; allowing the user to operate the ADD to automatically cut the one or more teeth of the subject at an exterior of the one or more teeth; allowing the apparatus to either retain or funnel particulate runoffs to suction ports within the apparatus during the tooth cutting; allowing the user to uncouple the apparatus from the ADD system subsequent to the tooth cutting; and allowing the user to unclamp the one or more jaws from the subject.

Another aspect provided herein is an apparatus for dental clamping of a subject, the apparatus comprising: one or more frames comprising one or more coupling points, wherein the one or more coupling points reversibly couple the apparatus to a system configured for a dental procedure; and one or more jaws, each comprising a first and second surface, the first surface comprises a shape adapted to fit one or more teeth of the subject and the second surface for attachment to the one or more frames.

In some embodiments, the one or more suction ports are configured to connect to more than one orifice located at different portions of the apparatus. In some embodiments, the one or more suction ports are attached on the one or more frames, the one or more jaws, the one or more teeth of the subject, or a combination thereof In some embodiments, the system configured for a dental procedure is an automated dental drill (ADD) system configured for tooth cutting or tooth drilling. In some embodiments, the system configured for a dental procedure is a root canal system. In some embodiments, the one or more jaws provide positional reference to the dental procedure by the system or an identical positional environment of the one or more teeth relative to the system. In some embodiments, the one or more jaws provide positional reference to the tooth cutting or tooth drilling by the ADD system or an identical positional environment of the one or more teeth relative to the ADD system. In some embodiments, the first surface is fabricated based on surface data, a three-dimensional model, or both of the one or more teeth as determined by tooth-scanning techniques (such as but not limited to use of a Dentsply Sirona CEREC or Align Technologies intraoral scanning device). In some embodiments, the one or more jaws provide the identical positional environment of the one or more teeth relative to the ADD system at different time points. In some embodiments, the one or more coupling points are configured for fixedly coupling the apparatus to the automated dental drill (ADD) system during tooth cutting. In some embodiments, relative movement of the apparatus to the ADD system during tooth cutting is within that of clinically acceptable thresholds. In some embodiments, the ADD system is configured for intraoral dental prosthetic preparation via automated tooth cutting. In some embodiments, the first surface envelopes a corresponding surface of the one or more teeth. In some embodiments, the one or more frames comprise one or more rigid materials. In some embodiments, the one or more jaws comprise one or more rigid materials. In some embodiments, the one or more rigid materials comprise one or more of: plastic, composite, metal, glass, porcelain, rubber, and alloy. In some embodiments, the one or more rigid materials comprise one or more of: polyether ether ketone (PEEK), polycarbonate, and acrylic. In some embodiments, the one or more jaws are fabricated using standard sized rigid materials using three-dimensional printing, molding, casting, computer numerical control (CNC), and/or machining with a toolpath. In some embodiments, the identical positional environment of the one or more teeth relative to the ADD system at different time points comprises one or more degrees of freedom that are substantially zero. In some embodiments, the shape of the first surface or the second surface is three-dimensional. In some embodiments, the shape of the first surface is selected from a collection of pre-existing shapes.

Another aspect provided herein is an apparatus for dental clamping of a subject, the apparatus comprising: one or more frames comprising one or more coupling points, wherein the one or more coupling points reversibly couple the apparatus to a system configured for a dental procedure; and one or more jaws, each comprising a first and second surface, the first surface comprises a shape adapted to fit one or more teeth of the subject and the second surface for attachment to the one or more frames.

In some embodiments, the one or more jaws provide positional reference to the dental procedure by the system. In some embodiments, the system configured for a dental procedure 1) is an automated dental drill (ADD) system configured for tooth cutting or tooth drilling; and/or 2) comprises a laser source, laser control system, light-transmitting optics, beam-steering optics and control system, and shutter. In some embodiments, the one or more irrigation orifices are located at or close to a distal end of the system configured for a dental procedure. In some embodiments, the one or more irrigation orifices are located to surround a tooth cutting or tooth drilling burr of the system. In some embodiments, the system configured for a dental procedure is a root canal system. In some embodiments, the one or more jaws provide positional reference to the dental procedure by the system or an identical positional environment of the one or more teeth relative to the system. In some embodiments, the first surface is fabricated based on surface data, a three-dimensional model, or both of the one or more teeth of the subject, representing a surface of the one or more teeth at the time of scanning. In some embodiments, the one or more coupling points are configured for fixedly coupling the apparatus to the automated dental drill (ADD) system during tooth cutting. In some embodiments, relative movement of the apparatus to the ADD system during tooth cutting is within that of clinically acceptable thresholds. In some embodiments, the ADD system is configured for intraoral dental prosthetic preparation via automated tooth cutting. In some embodiments, the second surface envelopes a corresponding surface of the one or more teeth. In some embodiments, the one or more frames comprise one or more rigid materials. In some embodiments, the one or more jaws comprise one or more rigid materials. In some embodiments, the one or more rigid materials comprise one or more of: plastic, composite, metal, glass, porcelain, rubber, and alloy. In some embodiments, the one or more rigid materials comprise one or more of: Polyether ether ketone (PEEK), polycarbonate, and acrylic. In some embodiments, the one or more jaws are fabricated using standard sized rigid materials using three-dimensional printing, molding, casting, computer numerical control (CNC), and/or machining with a toolpath. In some embodiments, the identical positional environment of the one or more teeth relative to the ADD system at different time points comprises one or more degrees of freedom that are substantially zero. In some embodiments, the shape of the first surface or the second surface is three-dimensional. In some embodiments, the one or more suction ports are configured to connect to more than one orifice located at different portions of the apparatus. In some embodiments, the shape of the first surface is selected from a collection of pre-existing shapes.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a side view illustration of an exemplary automated dental drill (ADD) system, in accordance with an embodiment herein;

FIG. 2 shows a perspective view illustration of an exemplary ADD system treating a patient, in accordance with in embodiment herein;

FIG. 3 shows a side cross sectioned view illustration of an exemplary ADD system treating a patient, in accordance with in embodiment herein;

FIG. 4 shows a side cross sectioned view illustration of an exemplary ADD system, in accordance with in embodiment herein;

FIG. 5 shows a side view illustration of the components within an exemplary ADD system, in accordance with in embodiment herein;

FIG. 6 shows an illustration of an exemplary first dental clamp, in accordance with an embodiment herein;

FIG. 7 shows an illustration of an exemplary second dental clamp, in accordance with an embodiment herein;

FIG. 8 shows an illustration of an exemplary third dental clamp, in accordance with an embodiment herein;

FIG. 9 shows an illustration of an exemplary first dental clamp, light guide, imaging sensor, and water flushing system, in accordance with an embodiment herein;

FIG. 10 shows an illustration of an exemplary second dental clamp, light guide, imaging sensor, and water flushing system, in accordance with an embodiment herein;

FIG. 11 shows an illustration of an exemplary laser ADD system, in accordance with an embodiment herein;

FIG. 12 shows an illustration of an exemplary dental treatment system, in accordance with an embodiment herein. and

FIG. 13 shows a non-limiting example of a computing device; in this case, a device with one or more processors, memory, storage, and a network interface.

### DETAILED DESCRIPTION

Many existing dental treatment apparatuses and systems are not capable of automated dental treatment, e.g., automated tooth cutting. Existing apparatuses and systems experience a major technical challenge and regulatory risks rely towards automated dental treatment due to the large working envelope of possible damage. Thus, there is an urgent and unmet need for automating dental treatment with cost-effective, safe, and reliable apparatuses and systems. As such, provided herein, are devices and systems for cutting teeth for crowns or dental drilling in surgery. The present disclosure relates to apparatuses, systems and methods for automating dental treatment.

In some embodiments, the present disclosure herein includes a tooth clamp which connects a computer numerical control (CNC) directed system to one or more teeth of the subject. In some embodiments, the tooth clamps disclosed herein are fabricated based on surface data of teeth of the subject. In some embodiments, the tooth clamp includes a specifically fabricated surface that mates to the surface of the tooth of the subject. Such a tooth clamp acts to retain teeth, protect soft tissue of the subject, provide positional reference to the CNC, and provide an identical positional environment of the teeth relative to the CNC at different time points. Unlike existing systems and methods for dental surgery locating, the systems and methods here eliminate the need for fiducial tracking through optical means by relying on mechanical coupling mechanism(s) for accurate, reliable, and efficient dental positioning, e.g., identical positioning of teeth in two different visits relative to the system for dental treatment. In some embodiments, the tooth clamp herein provide anchoring for irrigation and/or suction apparatuses that are also used in automated dental treatment. In some embodiments, the apparatus, systems, and methods herein includes dental adhesives, irrigation, suction, protection of the soft tissue that can work in combination with the tooth clamp or alone by themselves to facilitate automated dental treatment.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by 10%, 5%, or 1%, including increments therein.

The term “subject” as used herein refers to a human patient in need of dental treatment or a human control subject.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Automated Dental Drill

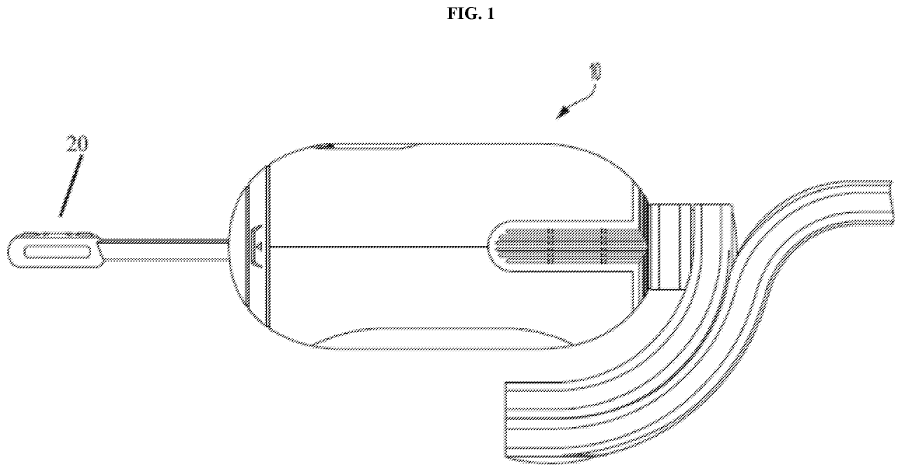

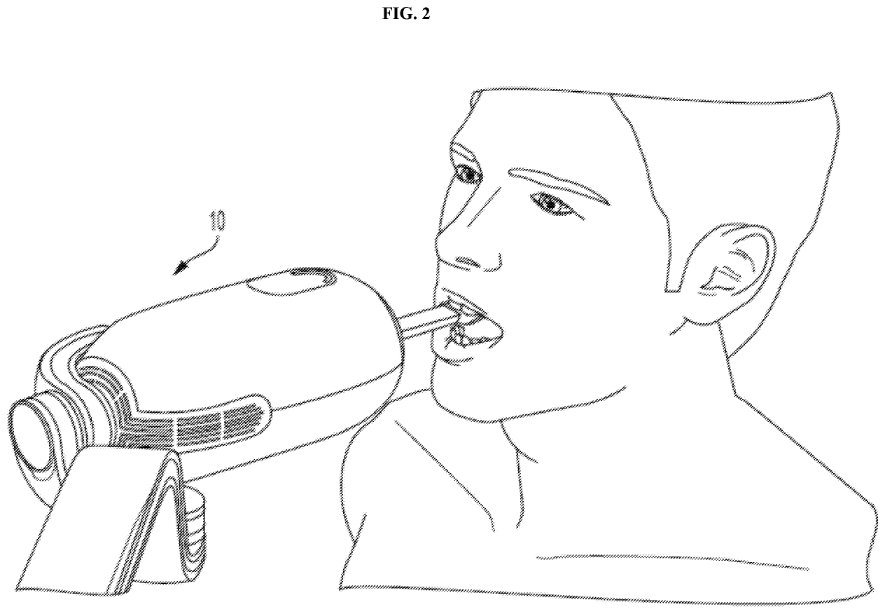

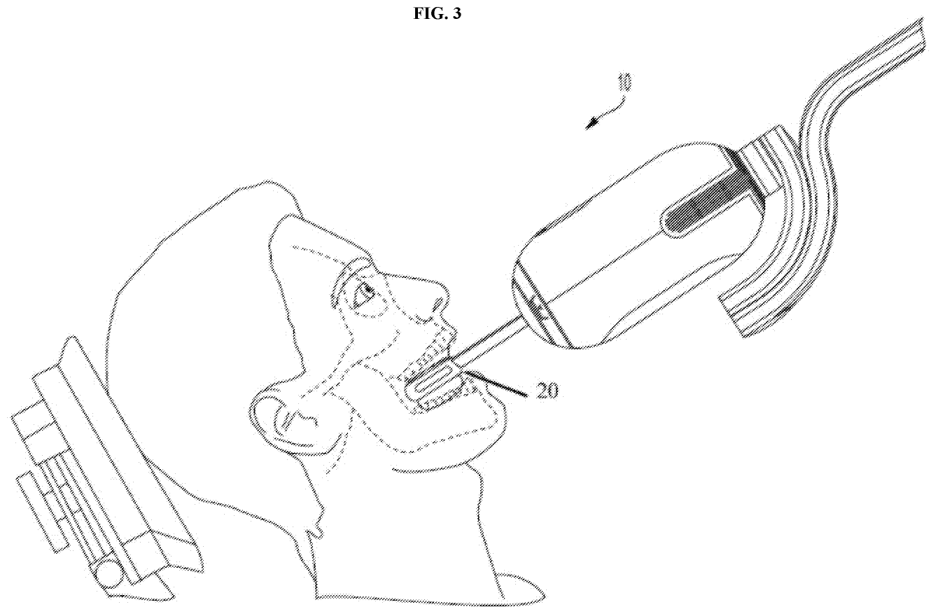

Referring to FIGS. 1-3, provided herein are an automated dental drill (ADD) system 10 and a dental clamp 20 configured to position the ADD system 10. The dental clamp 20 disclosed herein can be placed in a subject's oral cavity and connected to the ADD system 10 for a dental procedure. In some embodiments, the system is an automated dental drill (ADD) system. In some embodiments, the automated dental drill (ADD) cuts using a mechanical burr. In some embodiments, the automated dental drill (ADD) cuts using a focused laser beam. In some embodiments, the ADD system is configured for intraoral dental prosthetic preparation via automated tooth cutting. In some embodiments, the system is configured to perform a root canal. In some embodiments, the system configured for a dental procedure is configured for automatic tooth cutting, tooth drilling, or both.

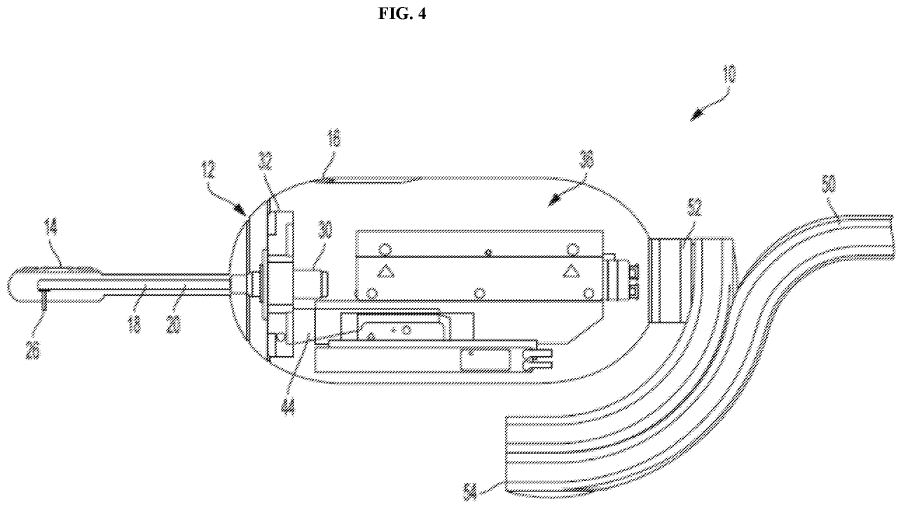

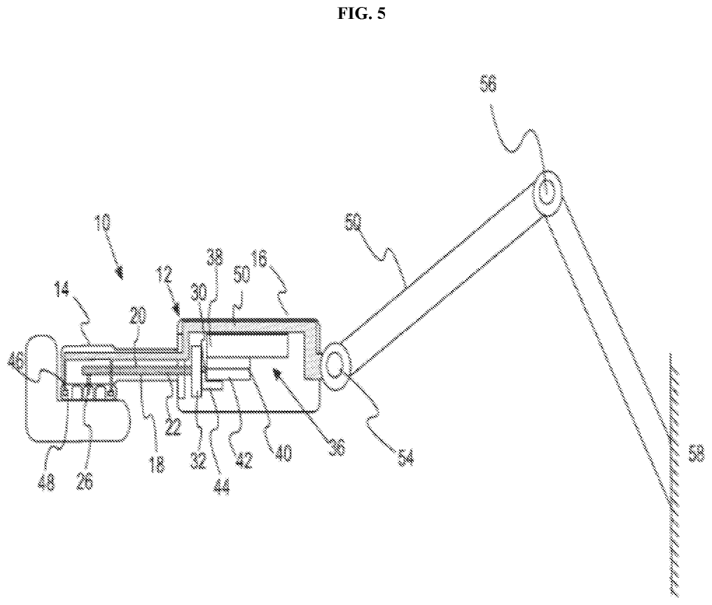

FIGS. 4 and 5 show schematic illustrations of an automated drill are provided. The dental drill 10 can comprise a dental drill housing 12 which includes mouth piece housing section 14 attached to translational drive housing section 16. The mouth piece housing section 14 can be configured to at least be partially positioned in a subject's mouth during an operation. The end effector drive support 18 can be disposed in dental drill housing 12. At least a portion of end effector drive support 18 can be movably positioned in mouth piece housing section 14. The mouth piece housing section 14 can comprise a shaft section 20 that extends into the mouth piece housing section 14. In some embodiments, the shaft section 20 is hollow in order to allow coupling of the cutting mechanism driver to the end effector via a shaft 22.

Further, per FIGS. 4, 5, and 12 the end effector 88 can be attached to end effector drive support 18 and can be movable along three orthogonal linear directions (e.g., x, y, z) relative to mouth piece housing section 14. Alternatively, the end effector 88 can be attached to end effector drive support 18 and can be movable along six of more degrees of freedom relative to mouth piece housing section 14. In operation, the z direction is defined as normal to the tooth. The x and y directions can be defined as being perpendicular to the z direction. Typically, the end effector 88 is located at the end of the end effector drive support 18. The end effector 88 can protrude from the mouth piece housing section 14 and can be used for cutting of a native tooth, a dental appliance, or both to a desired tolerance and form. The cutting mechanism driver 30 can be coupled to the end effector 88 position. The end effector 88 can be positioned by the dental drill housing, through which a shaft can direct power to the end effector 88 (whether rotary for cutting burr, or electromagnetic for cutting laser).

In some embodiments, the automated dental drill 10 further includes a translational drive assembly 36 which drives end effector 88 along the three or more directions. The translational drive assembly 36 can comprise three or more translational drives that move an end effector 88 in three or more directions: z-direction drive 38, y-direction drive 40, and x-direction drive 42. Each of the z-direction drive 38, the y-direction drive 40, and the x-direction drive 42 can be actuated by a stepper drive, piezoelectric drive, servomotor drive, or any combination thereof. Each of the z-direction drive 38, the y-direction drive 40, and the x-direction drive 42 can be a stepper drive, piezoelectric drive, servomotor drive, or any combination thereof. A coupler 44 can be used to couple the movement of the three translational drives to cutting drive support 18 and end effector 88.

The automated dental drill 10 can also include a clamp connector 46 that attaches to the tooth clamp. The tooth clamp 48 can be attached to a subject's mouth about a tooth to be treated. The clamp connector 46 can be attached to a support system 50 which can be fixed to dental drill housing 12. The clamp 48 can be fabricated from scanned data of the target teeth's position and topography. The clamp 48 can reposition teeth to their original scanned position to correct for relative movement between scanning and clamping when placed on the teeth of the patient prior to cutting a given tooth. The translational drive assembly 36 can be zeroed to the clamp 48 before cutting. The translational drive assembly 36 can be mechanically coupled to the clamp 48 during cutting. In some embodiments, the tooth clamp 48 can be a 3D printed or molded clam-shell structure having internal surfaces that mate with the teeth in an ultrahigh precision fashion. During cutting, the end effector (e.g., the drill or laser) can cut through the plastic of the clamp to access the tooth material beneath. Since several teeth are held simultaneously by the tooth clamp internal surfaces, movement of the teeth is reduced during cutting.

In some embodiments, the automated dental drill 10 further includes a cantilever arm 50 and one or more gimbals 52, 54, 56 that allow passive positioning and support of the automated dental drill. The cantilever arm 50 can be anchored to a support structure 58 (e.g., a wall, cart, ceiling, floor, dental chair, etc.).

### Dental Clamps

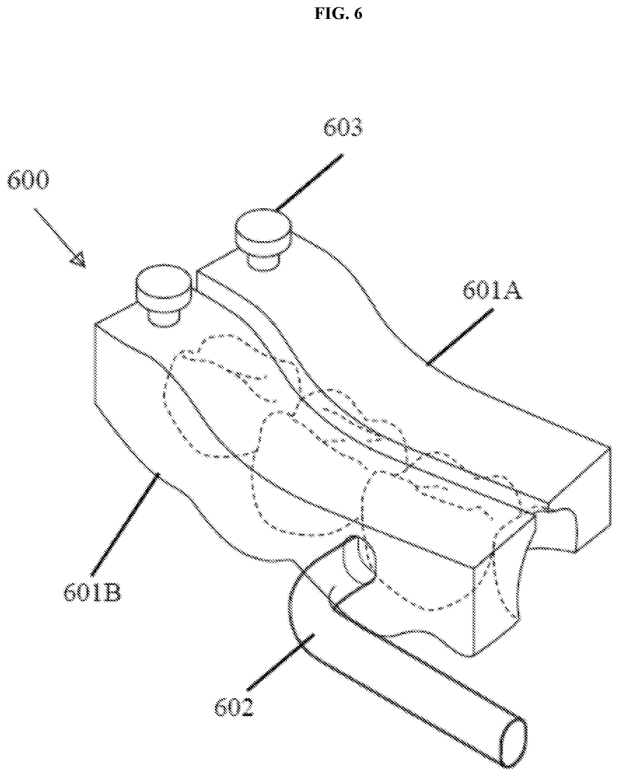

FIG. 6 shows an exemplary schematic diagram of a first tooth clamp apparatus 600 herein. In some embodiments, the first tooth clamp apparatus 600 comprises patient specific jaws 601A 601B, wherein each of the patient specific jaws 601A 601B comprises one or more coupling points 603. As shown, one or more of the patient specific jaws 601A 601B can comprise a suction tube 602.

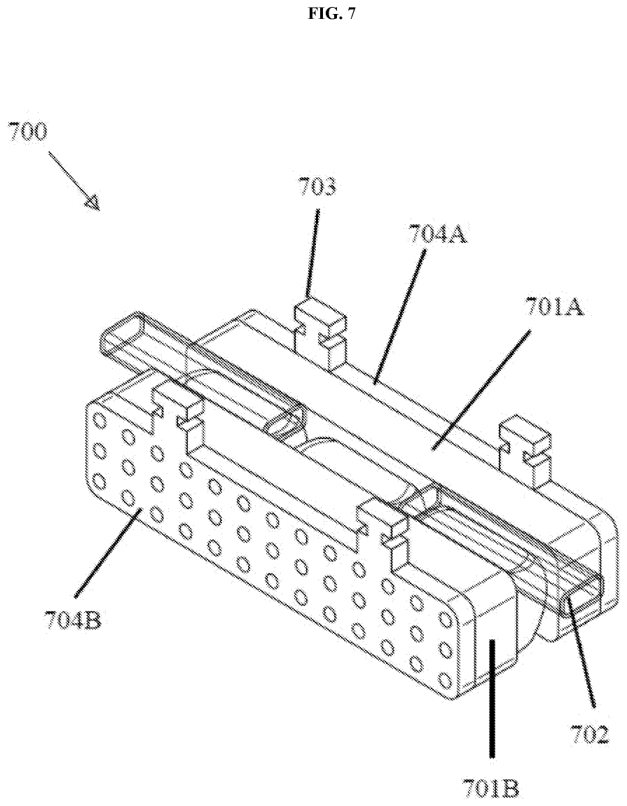

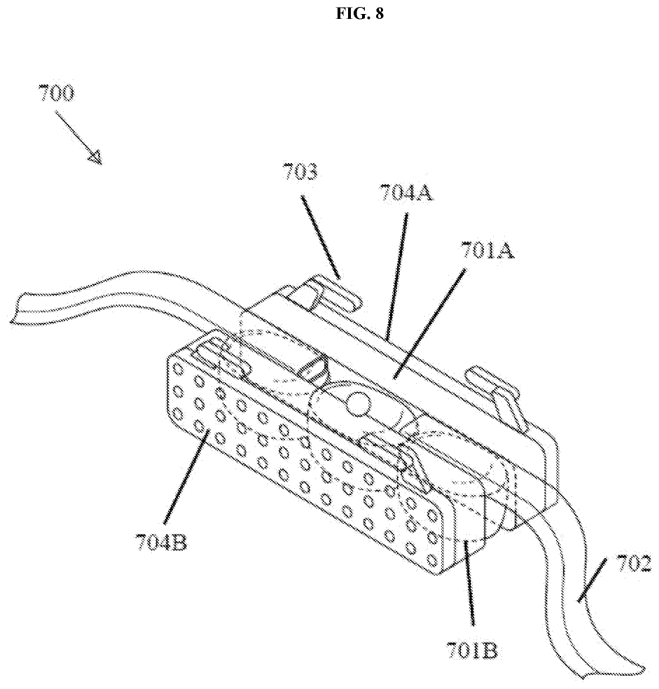

FIGS. 7-8 show exemplary schematic diagrams of a second tooth clamp apparatus 700 herein. In some embodiments, the tooth clamp 700 includes one or more frames 704A 704B by which it can be reversibly and fixedly coupled to the systems via one or more coupling points 703. The coupling points can have different geometrical shapes. In some embodiments, the frames 704A 704B also provide a platform to retain one or more jaws 701A 701B, e.g., patient specific jaws, which act to envelop the tooth surfaces along a single axis, e.g., along Y axis, from two opposite directions, effectively clamping one or more teeth. In some embodiments, the patient specific jaws 701A 701B includes the first surface 701A 701B comprises a shape adapted to mate with the tooth surface of one or more teeth of the subject and a second surface 701A 701B for attachment to the one or more frames 704A 704B. In some embodiments, the first surface 701A 701B envelopes a corresponding surface of the one or more teeth. In some embodiments, the shape of the first surface is selected from a collection of pre-existing shapes. In some embodiments, the first surface is three dimensional or two dimensional. In some embodiments, the second surface is three dimensional or two dimensional. Existing suction tubes 702 can be leveraged with special interfacial pieces to allow compatibility with engagement orifices on the dental clamp 700.

In some embodiments, the patient-specific jaws 701A 701B and the first surface 701A 701B are fabricated custom for each patient. In some embodiments, the first surface 701A 701B is generated at least partly based on three-dimensional surface data of one or more teeth of the subject. As a non-limiting example, teeth surface data is provided by a surface scanning system (such as but not limited to a Dentsply Sirona CEREC or Align Technologies intraoral scanning device). This teeth surface information can then be translated into a 3D model of the teeth, with a specific region picked for use based on the procedure (for one tooth or many teeth). In some embodiments, the 3D model of the teeth is then paired digitally with 3D models of standard-sized rigid material (e.g. plastic such as PEEK, Polycarbonate, Acrylic, etc., metal, polymer, etc) (whether a single stock size or a range). The overlap of 3D tooth model and standard-sized pieces can then be locked at a pre-determined position, and a fabrication method can be determined. In some embodiments, the fabrication method includes one or more of: three-dimensional printing, molding, casting, computer numerical control (CNC) machining, and/or machining with a toolpath Such method can be used to create cutaways in the standard sized pieces, and then the patient-specific jaws 701A 701B can be generated after removal of the cutaways. In some embodiment, fabrication of the jaws can be done either at the dental clinic where the diagnostics and treatment take place using in-house fabrication method (e.g., casting, CNC machining, or 3D printing), or alternatively at an external lab or centralized fabrication facility.

In some embodiments, fixation points on the tooth clamp 700 acts to secure a number of suction ports 702. In some embodiments, the suction ports 702 are configured for allowing removal of debris and cooling/flushing water curing or after tooth cutting. In some embodiments, the suction ports functions together with equipment(s) including but not limited to mechanisms to provide negative pressure within. Additional accessories can be added to equipment that provides negative pressure in the dental office. In some embodiments, the accessories include custom end orifices to couple the suction ports 702 to portions of the tooth clamp 700, along with necessary branching mechanisms such that one suction device can be made into several orifices to engage with the tooth clamp. In some embodiments, the suction ports 702 are configured to connect to more than one orifice located at different portions of the clamp. The suction ports can be attached on the one or more frames, the one or more jaws, the one or more teeth of the subject, or a combination thereof In some embodiments, the suction ports include flexible materials such as plastic, polymer, rubber, silicone, or the like. In some embodiments, the tooth clamp 700 includes one or more irrigation orifices. Such irrigation orifices can be located at or close to a distal end (the end that is closer to the subject than a proximal end) of the system configured for a dental procedure. In some embodiments, the one or more irrigation orifices are located to surround a tooth cutting or tooth drilling burr of the system. In some embodiments, the one or more irrigation orifices are located to allow passage of a laser beam used for tooth cutting or tooth drilling. In some embodiments, lasers and water irrigation can be consolidated in a coaxial fashion, whether overlapping or annular in cross section.

In some embodiments, such suction ports are the same as existing dental suction ports. In some embodiments, the irrigation orifices include a cross-section that is substantially circular. In some embodiments, the irrigation orifices include a cross-section that is of any arbitrary geometrical shapes, non-limiting examples of such shapes include oval, diamond, square, star, etc. In some embodiments, such irrigation orifices are the same as existing dental suction ports.

In some embodiments, the frames are of a single standard size or a range of standard sizes to allow for high volume fabrication prior to custom patient-specific jaw fabrication.

In some embodiments, the coupling points on the patient-specific jaws provides fixation of the tooth clamp to the system, e.g., ADD system, such that all degrees of freedom are substantially zero. In some embodiments, relative movement of the tooth clamp to the system during a dental procedure is within that of clinically acceptable thresholds. In some embodiments, the coupling points provides fixation such that the maximal relative movement of the tooth clamp with respect to the system is substantially zero. In some embodiments, such fixation can allow the system to enclose the tooth clamp and ensure that debris is contained within the tooth clamp. In some embodiments, such fixation advantageous allows the suction port 702 to effectively and efficiently remove any rinsed material and excess flushing water. In some embodiments, the system performs a dental treatment or procedure with the tooth clamp attached thereon. For example, the dental drilling head within the ADD can execute a cut to the desired tooth. Once the operation is complete, the ADD can be removed from the tooth clamp, and the tooth clamp can then be removed from the teeth of the patient, allowing the clinician to complete their work on the target tooth/teeth.

In some embodiments, the tooth clamp can be installed onto the teeth through clamping force directed either through screw leverage, material elastic force (analogous to traditional tooth clamp), tensioned band force via screw leverage (see traditional dental band clamp), or any other applicable means to squeeze the two frame/patient-specific jaws in a parallel and opposing fashion, e.g., along the Y-axis, to clamp the exterior of the target region of teeth.

In some embodiments, the tooth clamp is installed onto the teeth through adhesive force using an adhesive applied on the one or more jaws. In some embodiments, the adhesive is at least partly on the first surface. Such adhesive force can be activated by an initial clamping force, squeezing force or the like to allow sufficient contact of the adhesive with the tooth surfaces. The initial force can be removed after the adhesive force has taken place.

In some embodiments, the coupling points, the jaw(s), the frame(s), or a combination thereof includes rigid or semi-rigid material(s). In some embodiments, the rigid material(s) include one or more of: plastic, composite, metal, glass, porcelain, rubber, and alloy. In some embodiments, the rigid material(s) include one or more of: polyether ether ketone (PEEK), polycarbonate, and acrylic.

### ADD Systems

In some embodiments, the tooth clamp disclosed herein that can be used along with the system for dental procedures allows for a datum to be set for machining. The tooth clamp can act to couple the ADD system's coordinates to that of the dental anatomy, thereby allowing the ADD system to track where it is in reference to the teeth. Therefore, the tooth clamp can allow a common datum to be set between the two systems, a datum can be an origin by which a common (Cartesian, cylindrical, spherical, etc.) coordinate system is set.

In some embodiments, the datum is provided through coupling the system to known points on the frames and tracking known points through the tooth clamp to a known position on a given tooth, within an acceptable tolerance derived from the process of creating the dental clamp. Thus, the one or more jaws can provide positional reference during a dental procedure. In some embodiments, the one or more jaws provide an identical positional environment of the one or more teeth relative to the system at different time points. In some embodiments, this advantageously ensures that as between the time when teeth are scanned and the operation takes place, teeth can move, but the tooth clamp can reposition the teeth to their previously scanned position as the patient-specific jaws are fabricated to match the geometries and positions of the teeth when they are scanned.

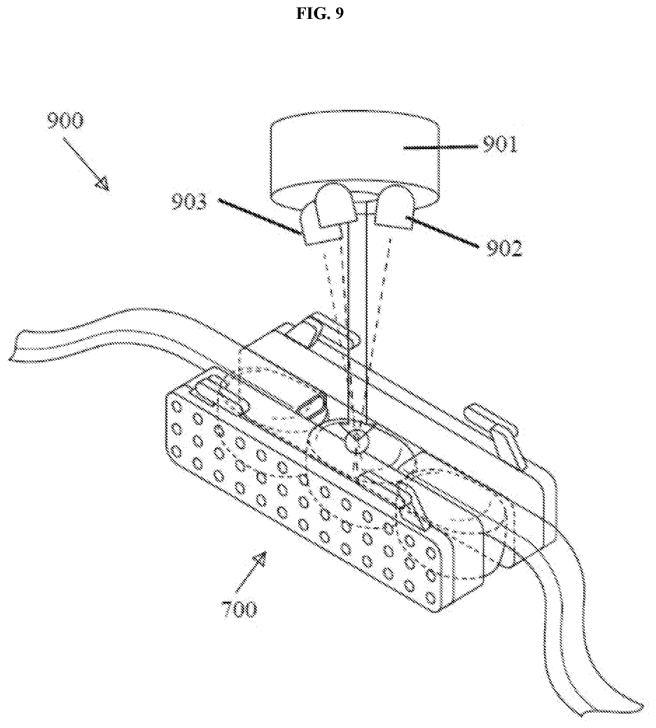

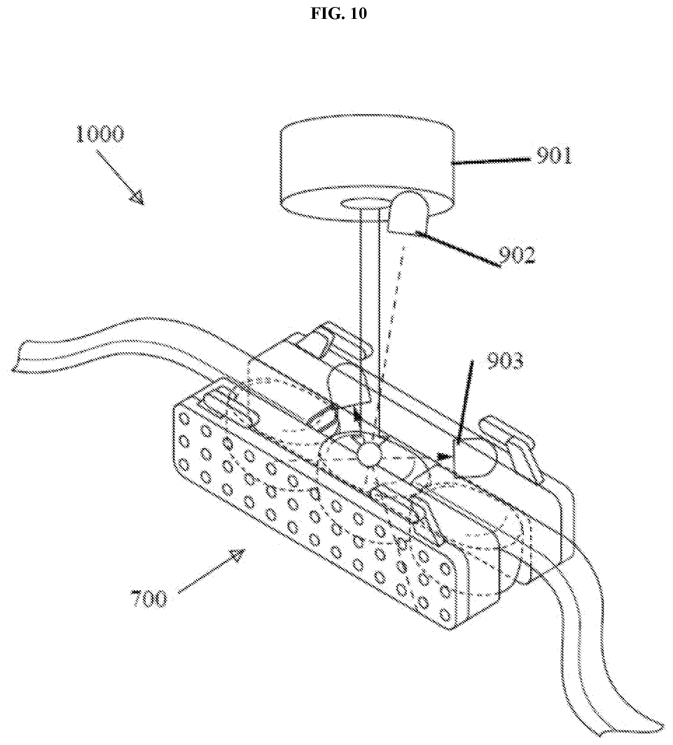

As seen in FIGS. 9 and 10, in some embodiments, the ADD system 900 comprises a clamp 700, a light guide 901 configured to transfer a laser from a laser generator, a sensor 902, and an irrigation nozzle 903. In some embodiments, the tooth clamp system 900 incorporates one or more sensors 902 to measure the current dimensions of the tooth during the process. In some embodiments, the ADD system 900 can comprise two or more sensors 902 and two or more irrigation nozzles 903. As seen in FIG. 9, the sensors 902 and the irrigation nozzles 903 can be attached to the light guide 901. Alternatively, per FIG. 10, the irrigation nozzles 903 can be attached to the clamp 700. In some embodiments, at least one of the sensors 902 and the irrigation nozzles 903 can be attached to the claim 700.

In some embodiments, the sensors 902 are optical. In some embodiments, the sensors 902 determine the current dimensions of the tooth using machine-vision (image analysis). In some embodiments, the sensors 902 use optical-coherence tomography to determine the current dimensions of the tooth. In some embodiments, the sensors 902 use speckle interferometry to determine the current dimensions of the tooth. In some embodiments, the sensors 902 use ultrasound to determine the current dimensions of the tooth. In some embodiments, the current dimensions of the tooth as determined by the sensors 902 are compared to the surgical plan to determine the progress of the dental procedure.

In some embodiments, the current dimensions of the tooth as determined by the sensors 902 are compared to prior dimensions of the tooth to determine the rate of tissue removal. In some embodiments, the prior dimensions of the tooth are determined using previous measurements by the sensors 902 during the same procedure. In some embodiments, the prior dimensions of the tooth are determined using prior measurements of the tooth performed using other means which will be apparent to those knowledgeable in the art. As a non-limiting example, teeth surface data is provided by a surface scanning system (such as but not limited to a Dentsply Sirona CEREC or Align Technologies intraoral scanning device).

In some embodiments, the current and past dimensions of the tooth are used to control the cutting speed of the automated dental drill (ADD) for optimal tissue removal. In some embodiments, the rate of tissue removal (as determined by current and past dimensions of the tooth) is used to distinguish healthy tissue from unhealthy tissue. As a non-limiting example, dense tooth material will cut or ablate at a lower rate than caries. In some embodiments, the rate of tissue removal (as determined by current and past dimensions of the tooth) is used to distinguish gingiva from tooth. In some embodiments, the spatial distribution of tissue-removal rate is used to determine the extent of tissue to be removed, and determine the progress and completion of the procedure.

In some embodiments, the determination of procedural progress or completion, as determined using the tissue-removal rate, is performed using an automated control system. As a non-limiting example, the automated control system can be implemented using a computer. As another non-limiting example, the automated control system can be implemented using a microcontroller. As a third non-limiting example, the automated control system can be implemented using a Field-Programmable Gate Array (FPGA).

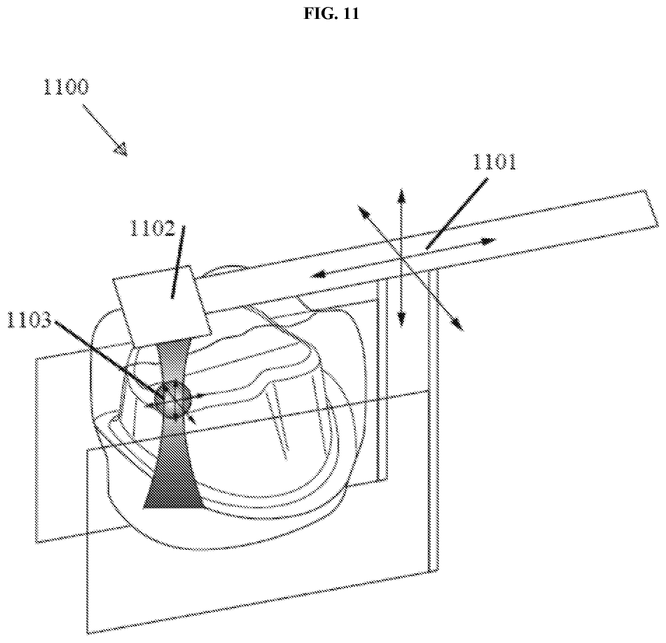

Per FIG. 11, the ADD system 100 can comprise a translational drive assembly 1101 and a laser generating source 1102 that generates a laser beam for cutting or drilling of the teeth. In some embodiments, the laser generating source 1102 generates a concentrated beam within a specific treatment volume 1103, which may or may not be coincident with the surface of a tooth. The focused laser in the treatment volume 1103 can enable phase change (e.g. water microbubbles), chemical change (e.g. pIRL), multi-photon ionization, or any combination thereof within the tooth. In some embodiments, the laser is generated at the distal end of the system, e.g., by incorporating a laser generating source in an ADD system. In some embodiments, the laser is generated at a proximal end of the system and is transmitted to the distal end of the system. In some embodiments, the clamp can be sized (e.g., recessed along z direction) so that it allows laser access to the teeth of the subject.

In some embodiments, the laser beam has a wavelength of about 0.1 um to about 50 um. In some embodiments, the laser beam has a wavelength of about 0.1 μum to about 0.5 um, about 0.1 um to about 1 um, about 0.1 um to about 5 um, about 0.1 um to about 10 um, about 0.1 um to about 15 um, about 0.1 um to about 20 um, about 0.1 um to about 25 um, about 0.1 um to about 30 um, about 0.1 um to about 35 um, about 0.1 um to about 40 um, about 0.1 um to about 50 um, about 0.5 um to about 1 um, about 0.5 um to about 5 um, about 0.5 um to about 10 um, about 0.5 um to about 15 um, about 0.5 um to about 20 um, about 0.5 um to about 25 um, about 0.5 um to about 30 um, about 0.5 um to about 35 um, about 0.5 um to about 40 um, about 0.5 um to about 50 um, about 1 um to about 5 um, about 1 um to about 10 um, about 1 um to about 15 um, about 1 um to about 20 um, about 1 um to about 25 um, about 1 um to about 30 um, about 1 um to about 35 um, about 1 um to about 40 um, about 1 um to about 50 um, about 5 um to about 10 um, about 5 um to about 15 um, about 5 um to about 20 um, about 5 um to about 25 um, about 5 um to about 30 um, about 5 um to about 35 um, about 5 um to about 40 um, about 5 um to about 50 um, about 10 um to about 15 um, about 10 um to about 20 um, about 10 um to about 25 um, about 10 um to about 30 um, about 10 um to about 35 um, about 10 um to about 40 um, about 10 um to about 50 um, about 15 um to about 20 um, about 15 um to about 25 um, about 15 um to about 30 um, about 15 um to about 35 um, about 15 um to about 40 um, about 15 um to about 50 um, about 20 um to about 25 um, about 20 um to about 30 um, about 20 um to about 35 um, about 20 um to about 40 um, about 20 um to about 50 um, about 25 um to about 30 um, about 25 um to about 35 um, about 25 um to about 40 um, about 25 um to about 50 um, about 30 um to about 35 um, about 30 um to about 40 um, about 30 um to about 50 um, about 35 um to about 40 um, about 35 um to about 50 um, or about 40 um to about 50 um. In some embodiments, the laser beam has a wavelength of about 0.1 um, about 0.5 um, about 1 um, about 5 um, about 10 um, about 15 um, about 20 um, about 25 um, about 30 um, about 35 um, about 40 um, or about 50 um. In some embodiments, the laser beam has a wavelength of at least about 0.1 um, about 0.5 um, about 1 um, about 5 um, about 10 um, about 15 um, about 20 um, about 25 um, about 30 um, about 35 um, or about 40 um. In some embodiments, the laser beam has a wavelength of at most about 0.5 um, about 1 um, about 5 um, about 10 um, about 15 um, about 20 um, about 25 um, about 30 um, about 35 um, about 40 um, or about 50 um.

In some embodiments, the laser beam generated herein by the system is configured to provide different spot sizes suitable for different cutting or drilling applications. In some embodiments, the laser beam generated herein is switched on and off in a pulsed, periodic manner during cutting. In some embodiments, the duration and time between “on” pulses can be controlled to optimize the cutting or drilling process. In some embodiments, the optical power of the laser beam generated herein can be controlled to optimize the cutting or drilling process. In some embodiments, the optical power of the laser beam generated herein can be varied from pulse to pulse in order to optimize the cutting or drilling process. In some embodiments, the optical power of the laser beam generated herein can be varied within a pulse in order to optimize the cutting or drilling process. In some embodiments, the laser-beam spot can be scanned within a localized region of the tooth, to optimize removal of tooth material at that region. In some embodiments, the laser-beam spot can be scanned within a localized region of the tooth, to optimize removal of gingiva at that region. In some embodiments, several or all of the spot size, spot scanning pattern, pulse repletion rate, pulse duration, pulse duty cycle, pulse pattern, and laser optical power can be controlled in concert to optimize the removal of tooth material. In some embodiments, several or all of the spot size, spot scanning pattern, pulse repletion rate, pulse duration, pulse duty cycle, pulse pattern, and laser optical power can be controlled in concert to optimize the removal of gingiva.

In some embodiments, the laser generating source is titanium-sapphire (Ti:Sapph) laser. In some embodiments, the laser generating source emits light of wavelength between 0.65 μm and 1.10 μm. In some embodiments, the laser generating source emits light of center wavelength 0.78 μm. In some embodiments, the laser generating source emits light of center wavelength 0.80 μm.

In some embodiments, the laser generating source is a fiber laser, consisting of Ytterbium-doped silica fiber. In some embodiments, the laser generating source emits a range of wavelengths between about 1.00 μm and about 1.20 μm. In some embodiments, the laser generating source emits light of center wavelength of about 1.03 μm. In some embodiments, the laser generating source emits light of center wavelength of about 1.04 μm.

In some embodiments, the laser generating source is a fiber laser, consisting of Ytterbium-doped silica fiber. In some embodiments, the laser generating source emits a range of wavelengths between about 1.45 μm and about 1.65 μm. In some embodiments, the laser generating source emits light of center wavelength of about 1.55 μm.

In some embodiments, the laser generating source is an neodymium-doped yttrium aluminum garnet laser (neodymium YAG, Nd:YAG). In some embodiments, the laser generating source emits light having a wavelength of about 0.946 μm. In some embodiments, the laser generating source emits light having a wavelength of about 1.12 μm. In some embodiments, the laser generating source emits light having a wavelength of about 1.32 μm. In some embodiments, the laser generating source emits light having a wavelength of about 1.44 μm. In some embodiments, the laser generating source is an erbium-doped yttrium aluminum garnet laser (erbium YAG, Er:YAG). In some embodiments, the laser generating source emits light having a wavelength of about 2.94 μm.

In some embodiments, the laser generating source is a carbon-dioxide laser. In some embodiments, the laser generating source emits light having a wavelength of about 10 μm. In some embodiments, the laser generating source emits light having a wavelength of about 10.6 μm. In some embodiments, the laser generating source emits light having a wavelength of about 10.3 μm. In some embodiments, the laser generating source emits light having a wavelength of about 9.6 μm. In some embodiments, the laser generating source is a picosecond high-powered laser having a wavelength of about 3 μm.

In some embodiments, the laser generating source is a fiber laser, consisting of Erbium-doped fluoride glass fiber. In some embodiments, the laser generating source emits a range of wavelengths between about 2.0 μm and about 4.0 μm. In some embodiments, the laser generating source emits light of center wavelength 2.80 μm. Er3+Er3+-doped fluoride glass

In some embodiments, the laser generating source emits light of approximate wavelength 9.3 μm, nearing the peak absorption of hydroxyapatite. In some embodiments, the gain medium of the laser generating source is a carbon-dioxide gas that includes an oxygen-18 isotope. In some embodiments, the laser herein includes an isotopic CO₂ laser that vaporizes enamel and gingiva. In some embodiments, the laser is configured to allow fast and efficient cutting at any angle, with more speed, precision and less bleeding than traditional cutting or drilling methods. In some embodiments, the system comprising a laser beam for tooth or gingiva cutting or drilling does not require anesthesia of the subject.

In some embodiments, automation, e.g., through optical tracking methods, can required to judge how much material has been removed using the laser cutting methods and the laser generating system herein.

### Control Systems

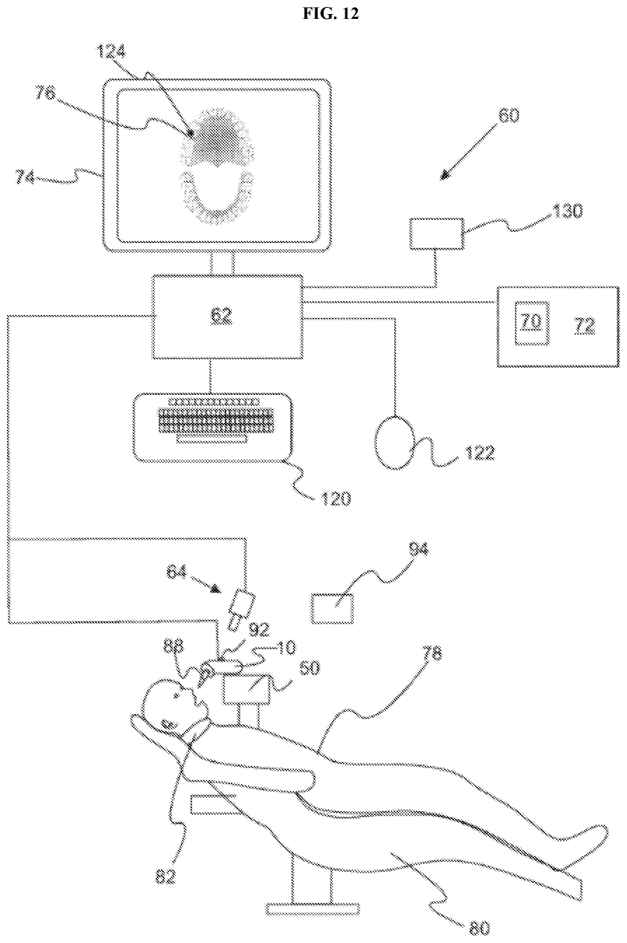

Referring to FIG. 12, the operation of dental treatment system 60 is described as follows. The central processing unit 62 can control the automated dental drill 10 to remove a region of the target tooth. The dental treatment system 60 can include input devices 120, 122 which can, for example, be a keyboard and mouse that receive surgical instructions from a user (i.e., dentist) for providing the surgical intervention. The instructions can be received by the central processing unit 62. Characteristically, the surgical instructions including visual indications 124 on the image of a target tooth are indications of the treatment. A control program 70 can guide the user through the dental protocols via a series of onscreen prompts (i.e., the user interface). In this context, actions attributable to control program 70 are understood to mean the execution of the relevant steps by central processing unit 62. In a variation, the dental treatment system 60 can include static memory 130 for storing patient profiles and records, which can be accessed by the user. In some embodiments, the central processing unit 62 can also display a load screen that shows a series of patient records and gives the option to load an existing patient, or create a new patient record.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

While various embodiments of the invention have been shown and described herein, it will be obvious to those skilled in the art that such embodiments are provided by way of example only. Numerous variations, changes, and substitutions can occur to those skilled in the art without departing from the invention. It should be understood that various alternatives to the embodiments of the invention described herein can be employed.

### Computing Systems

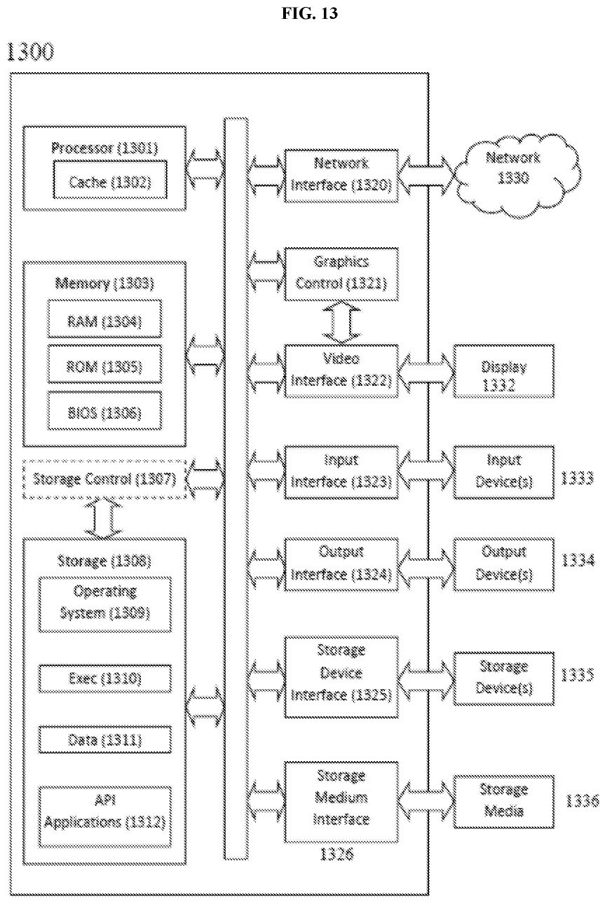

Referring to FIG. 13, a block diagram is shown depicting an exemplary machine that includes a computer system 1300 (e.g., a processing or computing system) within which a set of instructions can execute for causing a device to perform or execute any one or more of the aspects and/or methodologies for static code scheduling of the present disclosure. The components in FIG. 13 are examples only and do not limit the scope of use or functionality of any hardware, software, embedded logic component, or a combination of two or more such components implementing particular embodiments.

Computer system 1300 may include one or more processors 1301, a memory 1303, and a storage 1308 that communicate with each other, and with other components, via a bus 1340. The bus 1340 may also link a display 1332, one or more input devices 1333 (which may, for example, include a keypad, a keyboard, a mouse, a stylus, etc.), one or more output devices 1334, one or more storage devices 1335, and various tangible storage media 1336. All of these elements may interface directly or via one or more interfaces or adaptors to the bus 1340. For instance, the various tangible storage media 1336 can interface with the bus 1340 via storage medium interface 1326. Computer system 1300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1300 includes one or more processor(s) 1301 (e.g., central processing units (CPUs) or general purpose graphics processing units (GPGPUs)) that carry out functions. Processor(s) 1301 optionally contains a cache memory unit 1302 for temporary local storage of instructions, data, or computer addresses. Processor(s) 1301 are configured to assist in execution of computer readable instructions. Computer system 1300 may provide functionality for the components depicted in FIG. 13 as a result of the processor(s) 1301 executing non-transitory, processor-executable instructions embodied in one or more tangible computer-readable storage media, such as memory 1303, storage 1308, storage devices 1335, and/or storage medium 1336. The computer-readable media may store software that implements particular embodiments, and processor(s) 1301 may execute the software. Memory 1303 may read the software from one or more other computer-readable media (such as mass storage device(s) 1335, 1336) or from one or more other sources through a suitable interface, such as network interface 1320. The software may cause processor(s) 1301 to carry out one or more processes or one or more steps of one or more processes described or illustrated herein. Carrying out such processes or steps may include defining data structures stored in memory 1303 and modifying the data structures as directed by the software.

The memory 1303 may include various components (e.g., machine readable media) including, but not limited to, a random access memory component (e.g., RAM 1304) (e.g., static RAM (SRAM), dynamic RAM (DRAM), ferroelectric random access memory (FRAM), phase-change random access memory (PRAM), etc.), a read-only memory component (e.g., ROM 1305), and any combinations thereof. ROM 1305 may act to communicate data and instructions unidirectionally to processor(s) 1301, and RAM 1304 may act to communicate data and instructions bidirectionally with processor(s) 1301. ROM 1305 and RAM 1304 may include any suitable tangible computer-readable media described below. In one example, a basic input/output system 1306 (BIOS), including basic routines that help to transfer information between elements within computer system 1300, such as during start-up, may be stored in the memory 1303.

Fixed storage 1308 is connected bidirectionally to processor(s) 1301, optionally through storage control unit 1307. Fixed storage 1308 provides additional data storage capacity and may also include any suitable tangible computer-readable media described herein. Storage 1308 may be used to store operating system 1309, executable(s) 1310, data 1311, applications 1312 (application programs), and the like. Storage 1308 can also include an optical disk drive, a solid-state memory device (e.g., flash-based systems), or a combination of any of the above. Information in storage 1308 may, in appropriate cases, be incorporated as virtual memory in memory 1303.

In one example, storage device(s) 1335 may be removably interfaced with computer system 1300 (e.g., via an external port connector (not shown)) via a storage device interface 1325. Particularly, storage device(s) 1335 and an associated machine-readable medium may provide non-volatile and/or volatile storage of machine-readable instructions, data structures, program modules, and/or other data for the computer system 1300. In one example, software may reside, completely or partially, within a machine-readable medium on storage device(s) 1335. In another example, software may reside, completely or partially, within processor(s) 1301.

Bus 1340 connects a wide variety of subsystems. Herein, reference to a bus may encompass one or more digital signal lines serving a common function, where appropriate. Bus 1340 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1300 may also include an input device 1333. In one example, a user of computer system 1300 may enter commands and/or other information into computer system 1300 via input device(s) 1333. Examples of an input device(s) 1333 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1333 may be interfaced to bus 1340 via any of a variety of input interfaces 1323 (e.g., input interface 1323) including, but not limited to, serial, parallel, game port, USB, FIREWIRE, THUNDERBOLT, or any combination of the above.

In particular embodiments, when computer system 1300 is connected to network 1330, computer system 1300 may communicate with other devices, specifically mobile devices and enterprise systems, distributed computing systems, cloud storage systems, cloud computing systems, and the like, connected to network 1330. Communications to and from computer system 1300 may be sent through network interface 1320. For example, network interface 1320 may receive incoming communications (such as requests or responses from other devices) in the form of one or more packets (such as Internet Protocol (IP) packets) from network 1330, and computer system 1300 may store the incoming communications in memory 1303 for processing. Computer system 1300 may similarly store outgoing communications (such as requests or responses to other devices) in the form of one or more packets in memory 1303 and communicated to network 1330 from network interface 1320. Processor(s) 1301 may access these communication packets stored in memory 1303 for processing.

Examples of the network interface 1320 include, but are not limited to, a network interface card, a modem, and any combination thereof. Examples of a network 1330 or network segment 1330 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1330, may employ a wired and/or a wireless mode of communication. In general, any network topology may be used.

Information and data can be displayed through a display 1332. Examples of a display 1332 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1332 can interface to the processor(s) 1301, memory 1303, and fixed storage 1308, as well as other devices, such as input device(s) 1333, via the bus 1340. The display 1332 is linked to the bus 1340 via a video interface 1322, and transport of data between the display 1332 and the bus 1340 can be controlled via the graphics control 1321. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1332, computer system 1300 may include one or more other peripheral output devices 1334 including, but not limited to, an audio speaker, a printer, a storage device, and any combinations thereof. Such peripheral output devices may be connected to the bus 1340 via an output interface 1324. Examples of an output interface 1324 include, but are not limited to, a serial port, a parallel connection, a USB port, a FIREWIRE port, a THUNDERBOLT port, and any combinations thereof.

In addition or as an alternative, computer system 1300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein can be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An apparatus for dental clamping of a subject, the apparatus comprising:
(a) one or more frames, each frame comprising one or more coupling points, wherein the one or more coupling points reversibly couple the apparatus to an automated dental drill (ADD) system; and
(b) one or more jaws, each jaw comprising a first surface and second surface, wherein the first surface is configured to mate with one or more teeth of the subject, wherein the second surface is configured for attachment to the one or more frames, and wherein the one or more jaws and the one or more frames provide positional reference to the ADD system with respect to the one or more teeth of the subject.

2. The apparatus of claim 1, wherein the first surface is fabricated based on surface data, a three-dimensional model, or both of the one or more teeth of the subject, representing a surface of the one or more teeth at the time of scanning.

3. The apparatus of any one of claims 1-2, wherein the ADD system is configured to perform a dental procedure comprising a tooth cutting procedure or a drilling procedure.

4. The apparatus of any one of claims 1-3 further comprising one or more suction coupling points.

5. The apparatus of claim 4, wherein the one or more suction coupling points are configured to connect to one or more orifices within the one or more frames, the one or more jaws, or both.

6. The apparatus of any one of claims 1-5, wherein the one or more coupling points are configured to fixedly couple the apparatus to the ADD system during tooth cutting.

7. The apparatus of any one of claims 1-6, wherein the ADD system is configured for automated intraoral dental prosthetic preparation, intraoral dental surgery, or both.

8. The apparatus of any one of claims 1-7, wherein the first surface envelopes a surface of the one or more teeth.

9. The apparatus of any one of claims 1-8, wherein the one or more frames, the one or more jaws, or both are formed of a rigid material.

10. The apparatus of any one of claims 9, wherein the rigid material comprises: plastic, composite, metal, glass, porcelain, rubber, and alloy, polyether ether ketone (PEEK), polycarbonate, ceramic, a metal alloy, acrylic, or any combination thereof.

11. The apparatus of any one of claims 1-10, wherein the one or more jaws are fabricated using three-dimensional printing, molding, casting, computer numerical control (CNC) machining, or any combination thereof.

12. The apparatus of any one of claims 1-11, wherein the positional reference comprises a one or more degree of freedom positional reference.

13. The apparatus of any one of claims 1-12, wherein the shape of the first surface, the second surface, or both is two-dimensional or three-dimensional.

14. The apparatus of any one of claims 1-13 further comprising an adhesive configured to adhere the one or more jaws to the one or more teeth of the subject.

15. The apparatus of claim 14, wherein the adhesive is attached to at least a portion of the first surface.

16. The apparatus of any one of claims 1-15, wherein at least a portion of the first surface is generated based on three-dimensional surface data of the one or more teeth of the subject.

17. The apparatus of claim 16, wherein the three-dimensional surface data is generated based on one or more of: a two-dimensional visual spectrum light-based image, a three-dimensional visual spectrum light-based image, a two-dimensional X-ray image, a three-dimensional X-ray image, or a three-dimensional computed tomography (CT) scan.

18. The apparatus of claim 16, wherein the three-dimensional surface data is generated based on one or more of: a three-dimensional visual spectrum light based mesh, a three-dimensional visual spectrum light based cloud, a two-dimensional X-ray mesh, a two-dimensional X-ray cloud, a three-dimensional X-ray mesh, a three-dimensional X-ray cloud, a three-dimensional computed tomography (CT) mesh, or a three-dimensional computed tomography (CT) cloud.

19. The apparatus of any one of claims 1-18, wherein a relative movement of the apparatus with respect to the ADD system during tooth cutting deviates less than 1 μm to 500 μm.

20. A method for dental clamping of a subject, the method comprising:
(a) providing a dental clamping apparatus to a user;
(b) clamping the dental clamping apparatus to one or more teeth of the subject;
(c) coupling the dental clamping apparatus to an automated dental drill (ADD) system at one or more coupling points;
(d) performing tooth cutting with the ADD on the subject;
(e) retaining or funneling a particulate runoff to a suction port within the dental clamping apparatus;
(f) decoupling the dental clamping apparatus from the ADD system; and
(g) unclamping the dental clamping apparatus from the subject.

21. The method of claim 20, wherein clamping the dental clamping apparatus to one or more teeth of the subject comprises a screw, a band, an adhesive, a friction fit, or any combination thereof.

22. An automated tooth cutting system for intraoral dental prosthetic preparation of a subject, the system comprising:
(a) an automated dental drill (ADD) system configured to automatically cut a tooth of the subject; and
(b) an apparatus for dental clamping to the subject, the apparatus comprising:
(i) one or more frames comprising one or more coupling points, wherein the one or more coupling points reversibly couple the apparatus to the ADD system during tooth cutting; and
(ii) one or more jaws, each of the one or more jaws comprising a first surface and second surface;
wherein the first surface is configured to engage one or more teeth of the subject, wherein the second surface is configured for attachment to the one or more frames, wherein the first surface is adapted to fit to the one or more teeth of the subject, wherein the one or more jaws provide positional reference to the tooth for the ADD system, and wherein the ADD system is configured to cut the one or more teeth automatically when the apparatus is coupled to the ADD and clamped on the one or more teeth.

23. An apparatus for dental clamping of a subject, the apparatus comprising:
(a) one or more frames, wherein each frame comprises one or more coupling points, and wherein the one or more coupling points reversibly couple the apparatus to a dental procedure system; and
(b) one or more jaws, wherein each frame comprises a first surface and second surface, wherein the first surface has a shape adapted to fit one or more teeth of the subject, and wherein the second surface is configured to attach to the one or more frames.

24. The apparatus of claim 22 further comprising one or more suction coupling ports.

25. The apparatus of claim 24, wherein the one or more suction ports are configured to connect to an orifice within the one or more jaws, within the one or more frames, or within the one or more jaws and the one or more frames.

26. The apparatus of any one of claims 22-25, wherein the dental procedure system is an automated dental drill (ADD) system configured for tooth cutting, tooth drilling, a root canal procedure, an automated intraoral dental surgical procedure, or any combination thereof.

27. The apparatus of claim 25, wherein the ADD system is configured to perform an automated intraoral dental prosthetic preparation procedure.

28. The apparatus of claim 26 or 27, wherein the one or more coupling points are configured to couple the apparatus to the ADD system during tooth cutting.

29. The apparatus of claim 26, 27, or 28, wherein a relative movement between the apparatus and the ADD system during use is within about 1 um to about 300 um.

30. The apparatus of any one of claims 23-29, wherein the one or more jaws provide positional reference to the dental procedure system.

31. The apparatus of claim 30, wherein the positional reference comprises one or more degrees of freedom positional reference.

32. The apparatus of any one of claims 23-31, wherein the shape of the first surface, the second surface, or both is two-dimensional or three-dimensional.

33. The apparatus of any one of claims 23-32, wherein the first surface is fabricated based on a surface data of the one or more teeth of the subject, a three-dimensional model of the one or more teeth of the subject, or both.

34. The apparatus of any one of claims 23-33, wherein the first surface envelopes a surface of the one or more teeth.

35. The apparatus of any one of claims 23-34, wherein the one or more frames, the one or more jaws, or both are formed of a rigid material.

36. The apparatus of any one of claims 35, wherein the rigid material comprises: plastic, composite, metal, glass, porcelain, rubber, and alloy, polyether ether ketone (PEEK), polycarbonate, acrylic, or any combination thereof.

37. The apparatus of any one of claims 23-36, wherein the one or more jaws are fabricated using three-dimensional printing, molding, casting, computer numerical control (CNC) machining, or any combination thereof.

38. The apparatus of any one of claims 23-37, wherein the dental procedure system further comprises a laser generating source.

39. The apparatus of claim 38, wherein the laser generating source is configured to generate a laser beam with a wavelength of about 0.1 μm to about 15 μm.

40. The apparatus of claim 38 or 39, wherein the laser generating source is at or near a distal end of the dental procedure system.

41. The apparatus of claim 38, 39, or 40, wherein the laser generating source is at a headpiece.

42. The apparatus of any one of claims 23-41, wherein the dental procedure system further comprises one or more irrigation orifices.

43. The apparatus of claim 42, wherein the one or more irrigation orifices are located at or close to a distal end of the dental procedure system.

44. The apparatus of claim 42 or 43, wherein the one or more irrigation orifices surround the end effector of the dental procedure system.
